(19) United States
(12) Patent Application Publication
(10) Pub. No.: US 2006/0166554 A1
(43) Pub. Date: Jul. 27, 2006

(54) Waterproof device for electrical connector

(75) Inventor: Teng-Sheng Hung, Shinjuang City (TW)

Correspondence Address: HDSL, 4331 STEVENS BATTLE LANE, FAIRFAX, VA, 22033, US

(73) Assignee: Liang Tei Co., Ltd

(21) Appl. No.: 11/043,737

(22) Filed: Jan. 27, 2005

(51) Int. Cl. H01R 13/40

(52) U.S. Cl. 439/589

(57) ABSTRACT

A waterproof device for an electrical connector includes a sleeve for containing a plug at front end thereof and having a resilient tightening section at another end thereof. A waterproof element is arranged in the resilient tightening section. A bolting cap is arranged on the outer end of the sleeve and tightens a peripheral of the waterproof element. Therefore, the waterproof element also tightens a cable of the plug. Therefore, the waterproof element wraps or caps one end of the cable and is compressed by the bolting cap to quickly assemble the waterproof device.

### BACKGROUND OF THE INVENTION

1. Field of the Invention

The present invention relates to a waterproof device for an electrical connector, and more particularly to a waterproof device for an electrical connector and having quick assembling.

2. Description of Prior Art

Conventional plug or socket for communication cable includes such as RJ11 or RJ45 plug/socket. The communication cable socket is generally arranged on the wall or the electronic device and the plug of a cable is inserted into the socket to provide connection, for example, telephone line connection or network connection. However, the conventional plug or socket for communication cable is not provided with waterproof function and there is short-circuit problem when water invades into the socket or plug.

The Taiwan Patent No. 562,282 filed by the same applicant discloses plug and socket with waterproof function. The waterproof plug and socket device is a blot type device and comprises a damper for clamping a socket and a barrel into which the plug is fit. The cable connected behind the plug extends from rear side of the barrel. A washer is capped to the barrel. The plug fit into the barrel is inserted into the socket clamped by the clamper such that the plug and the socket are engaged during application. Afterward, a bolt cap is tightened from rear end of the barrel and fixed to the barrel and the clamper. The barrel and washer are squeezed by the bolt to achieve waterproof effect. Finally, a screw cap is fit to rear end of the barrel and screwed to a thread formed on read end of the barrel to squeeze the cable for waterproof.

However, in above-mentioned waterproof plug and socket device, there is a waterproof cap provided on rear end of the barrel. The waterproof cap is abutted on rear end of the barrel when the bolt cap is tightened to rear end of the barrel. The waterproof cap has a through hole allowable only for the passing of the cable. Therefore, the plug should be cut from the cable when the plug is already connected with the cable at the beginning and the plug is to be assembled to the waterproof plug and socket device. The cut cable is then reconnected with the plug after the cable passes the through hole. It is time consuming and inconvenient.

### SUMMARY OF THE INVENTION

The present invention provide an waterproof device for an electrical connector wherein the waterproof device can be quickly assembled even when the connector has a cable connected thereon.

In one aspect of the present invention, the waterproof device includes a sleeve for containing a plug at front end thereof and a threading cap corresponding to a socket and capping to a front outer end of the sleeve. The sleeve further comprises a resilient tightening section at rear end thereof. A waterproof element is arranged in the resilient tightening section. The waterproof element is a resilient cylinder with a slit defined thereon. A bolting cap is arranged on the outer end of the sleeve and tightens the resilient tightening section. The waterproof element in the resilient tightening section is also compressed to clamp the cable therein.

In another aspect of the present invention, the sleeve comprises a connection cap and a fixing cap. The connection cap has a front portion with an inner shape fit with the shape of the plug such that the electrical plug is fit to the front portion of connection cap. A removable threading cap is fit to an outer portion of the connection cap. A washer is provided in the threading cap. The threading cap is screwed to the waterproof device when the plug is connected to a corresponding socket. The fixing cap is placed at rear end of the connection cap and a resilient tightening section is arranged at rear end of the fixing cap. The resilient tightening section comprises a plurality of spring tabs in ring arrangement. When the bolting cap is screwed to rear portion of the fixing cap, the compressing force on the spring tabs increases as the bolting cap is further screwed inward.

In still another aspect of the present invention, a clamping cap is provided in the sleeve. The clamping cap is placed at rear portion of the plug and abuts to the plug to prevent the plug from inward movement during inserting and extracting the plug.

The above summaries are intended to illustrate exemplary embodiments of the invention, which will be best understood in conjunction with the detailed description to follow, and are not intended to limit the scope of the appended claims.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded view of the waterproof device for electrical connector according to the present invention.

FIG. 2 is a perspective view of the waterproof device for electrical connector according to the present invention.

FIG. 3 is a front view of the waterproof device for electrical connector according to the present invention.

FIG. 4 is a sectional view along line 4-4 in FIG. 3.

FIG. 5 shows an exploded view of another preferred embodiment of the present

### DETAILED DESCRIPTION OF THE INVENTION

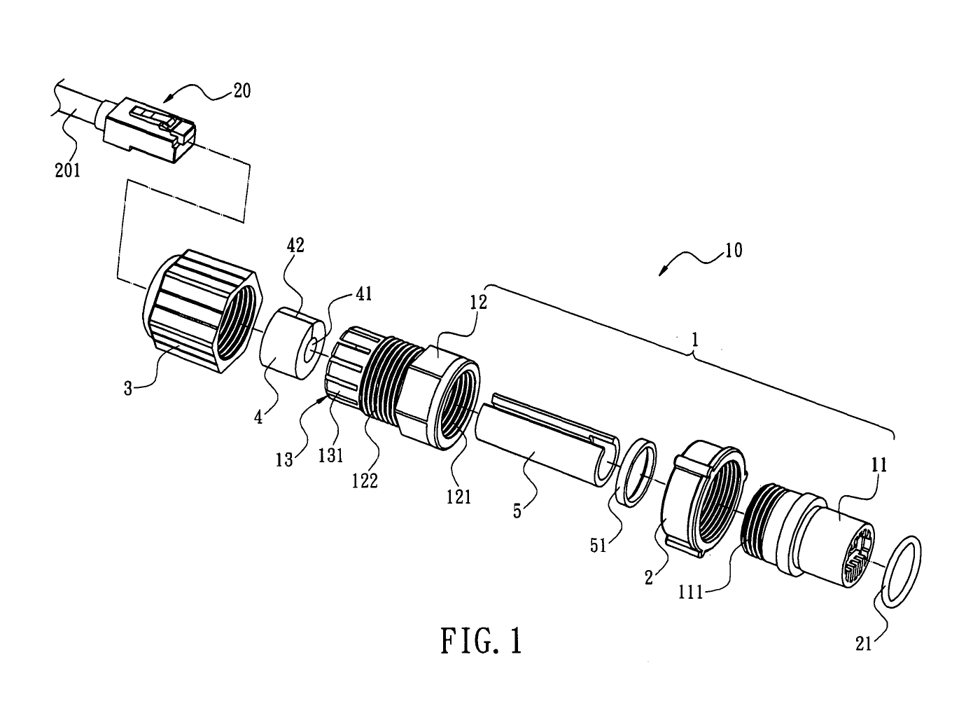

The present invention provides a waterproof device for an electrical plug. As shown in FIG. 1, the waterproof device 10 is used for an electrical plug 20 such as a telephone plug or a network line plug and mated with the electrical plug 20. The waterproof device 10 comprises sleeve 1 having a connection cap 11 and a fixing cap 12. The connection cap 11 has a front portion with an inner shape fit with the shape of the plug 20 such that the electrical plug 20 is fit to the front portion of connection cap 11. The connection cap 11 has an outer rear portion with a first thread section 111 thereon. A removable threading cap 2 is fit to the connection cap 11. A washer 21 is provided in the threading cap 2 and the connection cap 11. When the plug 20 is connected to a corresponding socket, the threading cap 2 is used to retain the waterproof device 10.

In the present invention, a second thread section 121 is provided in front inner portion of the fixing cap 12 and engaged with the first thread section 111. A resilient tightening section 13 is provided at rear portion of the fixing cap 12 and composed of a plurality of spring tabs 131 in ring arrangement. A third thread section 122 is provided at outer middle portion of the fixing cap 12 and a bolting cap 3 is screwed thereon. When the bolting cap 3 is screwed to rear portion of the fixing cap 12, the compressing force on the spring tabs 131 increases as the bolting cap 3 is further screwed inward.

With reference again to FIG. 1, a waterproof element 4 is provided in the resilient tightening section 13 and is a resilient cylinder composed of two semi-circular columns (not shown) or columns of other shapes. The resilient cylinder has a through hole 41 through which the cable 201 of the plug 20 passes. A slit 42 is defined on the waterproof element 4 such that the waterproof element 4 can be opened outward along the slit 42. A clamping cap 5 is provided in the sleeve 1 and comprises a fixing ring 51. The clamping cap 5 is placed at rear portion of the plug 20 and abuts to the plug 20 to prevent the plug 20 from inward movement during inserting and extracting the plug 20.

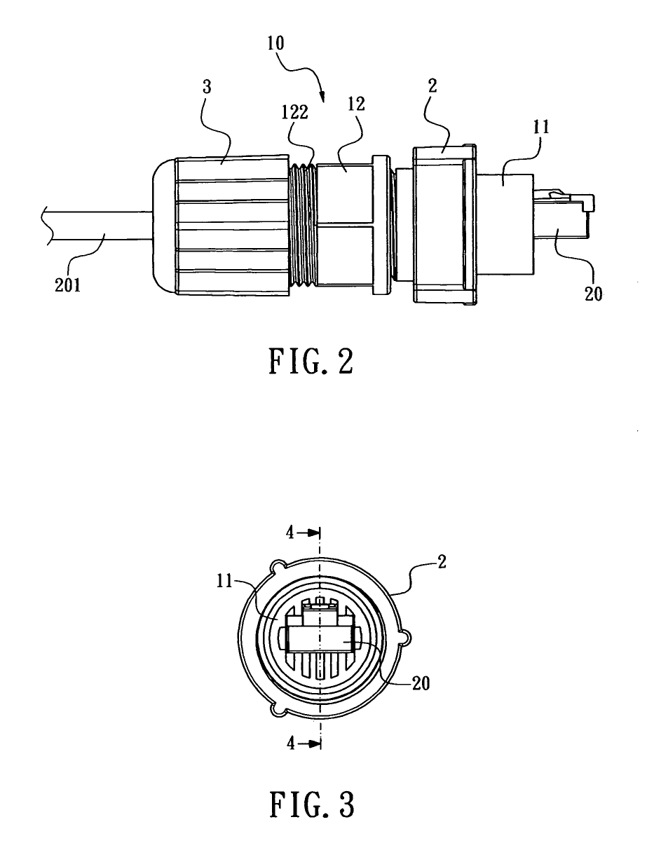

With reference to FIGS. 1 to 3, for assembling the waterproof device 10, the plug 20 is assembled to rear portion of the waterproof device 10. The plug 20 with the cable 201 passes the bolting cap 3, the waterproof element 4, the fixing cap 12, the clamping cap 5, and the connection cap 11 such that the plug 20 is fixed to the front end of the connection cap 11. When the plug 20 is to pass through the waterproof element 4, the waterproof element 4 is pulled to open through the slit 42 and then the cable 201 is inserted into the through hole 41 of the waterproof element 4.

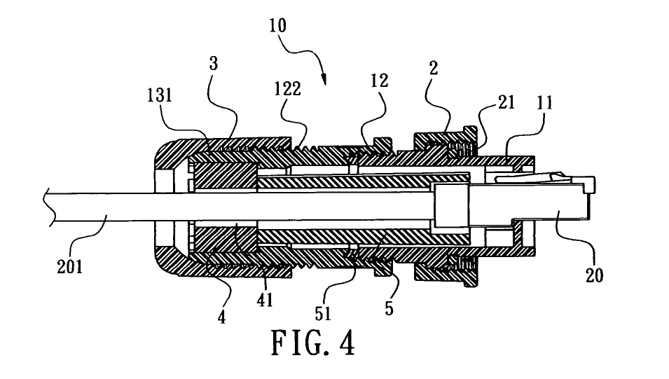

Afterward, the threading cap 2 is capped to the connection cap 11 and then the fixing cap 12 is screwed to the rear end of the connection cap 11. Finally, the bolting cap 3 is screwed to the fixing cap 12 and the resilient tightening section 13 is tightened by the bolting cap 3. Therefore, the waterproof element 4 in the resilient tightening section 13 is also compressed to clamp the cable 201. As shown in FIG. 4, the waterproof device 10 can be assembled to the plug 20 to render the plug 20 with waterproof function.

In the present invention, for passing the cable 201 of the plug 20 through the waterproof element 4, the user only needs to pull outward the waterproof element 4 tough the slit 42 and then the cable 201 can be quickly inserted into the through hole 41. The plug 20 can be easily assembled to the waterproof device 10 even though the plug 20 is connected with a cable 201.

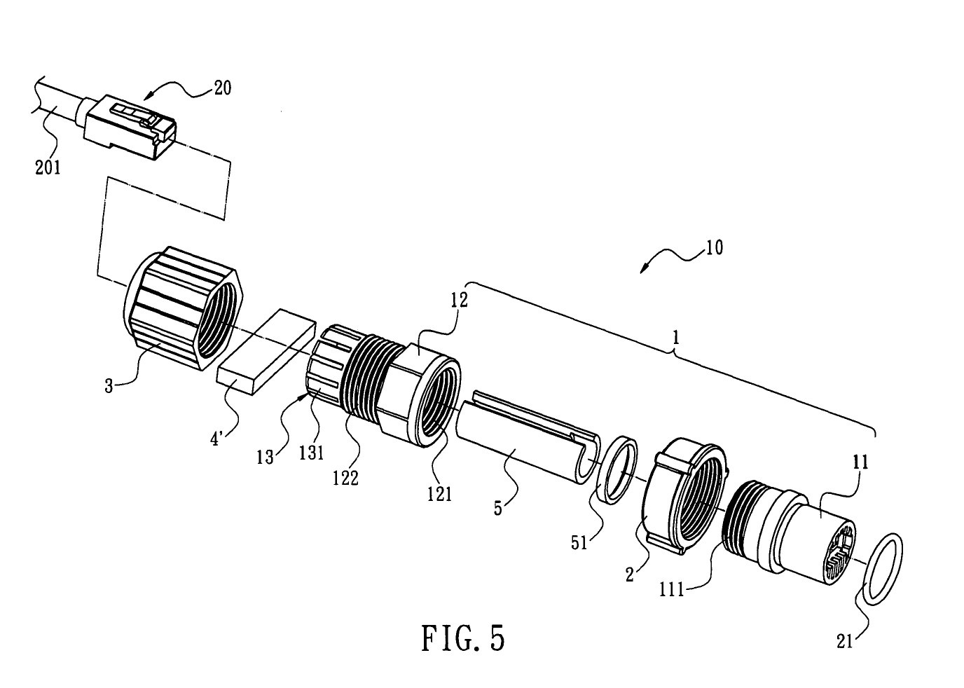

FIG. 5 shows the exploded view of another preferred embodiment of the present invention. The waterproof element 4 is modified into a waterproof element 4′ as shown in this figure. The waterproof element 4′ is a resilient plate for wrapping one end of the cable 201 of the plug 20 during usage. The waterproof element 4′ wrapping the cable 201 is then placed into the resilient tightening section 13. The resilient tightening section 13 is then compressed by screwing the bolting cap 3. The waterproof element 4′ is compressed with the resilient tightening section 13 to clamp the cable 201 of the plug 20.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A waterproof device for an electrical connector, comprising:
a sleeve comprising a connection cap having an outer first thread section at the rear portion, a fixing cap having an outer third thread section and a resilient tightening section comprising a plurality of spring tabs in ring arrangement at one end, and an inner second thread section at the other end, wherein a removable threading cap being connected to the first thread section and a washer being provided in-between the removable threading cap and the connection cap;
a waterproof element arranged in the resilient tightening section and being a resilient cylinder with a slit thereon; and
a bolting cap being tighten at the outer third thread of the sleeve and tightening a peripheral of the waterproof element.

2. The waterproof device for an electrical connector as in claim 1, wherein the electrical connector comprises a plug and cable connected to the plug.

3. The waterproof device for an electrical connector as in claim 2, wherein the plug is one of RJ 11 plug and RJ 45 plug.

4. The waterproof device for an electrical connector as in claim 2, wherein the plug has one end received in the sleeve and the waterproof element caps another end of the cable.

5-9. (canceled)

10. The waterproof device for an electrical connector as in claim 1, wherein the waterproof element comprises two longitudinal halves.

11. A waterproof device for an electrical connector, comprising
a sleeve comprising a resilient tightening section on one end thereof;
a waterproof element arranged in the resilient tightening section and being a resilient plate; and
a bolting cap arranged on the end of the sleeve and tightening a peripheral of the waterproof element.

12. The waterproof device for an electrical connector as in claim 11, wherein the electrical connector comprises a plug and cable connected to the plug.

13. The waterproof device for an electrical connector as in claim 12, wherein the plug is one of RJ 11 plug and RJ 45 plug.

14. The waterproof device for an electrical connector as in claim 12, wherein the plug has one end received in the sleeve and the waterproof element wraps another end of the cable.

15. The waterproof device for an electrical connector as in claim 11, wherein the sleeve comprises a connection cap and a fixing cap.

16. The waterproof device for an electrical connector as in claim 15, wherein the connection cap comprises a first thread section at an outer rear portion thereof, wherein a removable threading cap being connected to the first thread section and a washer being provided in-between the removable threading cap and the connection cap.

17. The waterproof device for an electrical connector as in claim 15, wherein the fixing cap has a second thread section on one end thereof and a third thread section and the resilient tightening section on another end thereof, the third thread section being tightened by the bolting cap.

18. The waterproof device for an electrical connector as in claim 17, wherein the tightening section comprises a plurality of spring tabs in ring arrangement.

19. The waterproof device for an electrical connector as in claim 11, wherein the tightening section comprises a plurality of spring tabs in ring arrangement.
